(19) United States
(12) Patent Application Publication
(10) Pub. No.: US 2025/0219970 A1
(43) Pub. Date: Jul. 3, 2025

(54) CONTEXTUAL CONVERSATIONAL USER ASSISTANCE

(71) Applicant: International Business Machines Corporation, Armonk, NY (US)

(72) Inventors: Logan Bailey, Atlanta, GA (US); Jeremy R. Fox, Georgetown, TX (US); Zachary A. Silverstein, Georgetown, TX (US); Justin David Weisz, Scarsdale, NY (US)

(21) Appl. No.: 18/402,798

(22) Filed: Jan. 3, 2024

(51) Int. Cl. H04L 51/02; G06F 40/30; G06F 40/40; G06Q 10/0631

(52) U.S. Cl. CPC H04L 51/02; G06F 40/30; G06F 40/40; G06Q 10/063114

(57) ABSTRACT

In an approach for providing contextual conversational user assistance, a processor monitors a plurality of inputs by a user to a computing device. Responsive to determining, based on the monitoring, that an error rate associated with the plurality of inputs has exceeded a threshold level, a processor invokes a conversational large learning model (LLM). A processor queries the user regarding a mental state and a task of the user using the conversational LLM. A processor identifies one or more methods to assist the user based on a response of the user to the querying. A processor executes the one or more methods identified to assist the user.

### BACKGROUND OF THE INVENTION

The present invention relates generally to the field of data processing, and more particularly to computer-implemented methods, computer systems, and computer program products configured and arranged for providing contextual conversational user assistance.

Generative artificial intelligence (AI), and more specifically the utilization of large language models (LLM) and conversational AI to augment and support a workforce, is a rapidly growing sector.

Generative artificial intelligence (AI) is a type of AI that generates a plurality of types of content, including text, speech, music, images, video, and code, while interpreting and manipulating pre-existing data. The machine-learning techniques behind generative AI have evolved over the past decade. The latest approach is based on a neural network architecture referred to as a “transformer.” Combining transformer architecture with unsupervised learning, large foundation models emerged that outperform existing benchmarks capable of handling multiple data modalities. Large foundation models serve as the starting point for the development of more advanced and complex models. By building on top of a foundation model, a more specialized and sophisticated model tailored to specific use cases or domains can be created.

Large language models (LLM) are a type of generative pretrained transformers (GPT) that can create human-like text and code. LLMs are explicitly trained on large amounts of text data for Natural Language Processing (NLP) tasks and contain a significant number of parameters, usually exceeding one hundred million. LLMs facilitate the processing and generation of natural language text for a plurality of diverse tasks.

### SUMMARY

Aspects of an embodiment of the present invention disclose a method, computer program product, and computer system for providing contextual conversational user assistance. A processor monitors a plurality of inputs by a user to a computing device. Responsive to determining, based on the monitoring, that an error rate associated with the plurality of inputs has exceeded a threshold level, a processor invokes a conversational large learning model (LLM). A processor queries the user regarding a mental state and a task of the user using the conversational LLM. A processor identifies one or more methods to assist the user based on a response of the user to the querying. A processor executes the one or more methods identified to assist the user.

In some aspects of an embodiment of the present invention, subsequent to invoking the conversational large learning model, a processor detects a sentiment of the user. A processor selects a persona of a plurality of personas for the conversational LLM to query the user based on the detected sentiment of the user.

In some aspects of an embodiment of the present invention, subsequent to querying the user regarding the mental state and the task of the user using the conversational LLM, a processor processes the response for an indication of frustration of the user. A processor processes the response for an indication of fatigue of the user.

In some aspects of an embodiment of the present invention, the indication of frustration includes at least one of a Natural Language component, a speech, a language choice, a sentiment, and an expletive, and wherein the indication of fatigue includes at least one of a spelling error, a process indicator, and a process blind indicator.

In some aspects of an embodiment of the present invention, a processor analyzes one or more factors associated with an action the user is executing.

In some aspects of an embodiment of the present invention, the one or more factors associated with the action the user is executing include at least one of a degree of criticality of the action the user is executing, a timeline associated with the action the user is executing, and an urgency of the action the user is executing.

In some aspects of an embodiment of the present invention, the one or more methods identified to assist the user comprise at least one of helping the user with the task, chatting with the user to provide emotional support, and recommending that the user take a break.

These and other features and advantages of the present invention will be described in, or will become apparent to those of ordinary skill in the art in view of, the following detailed description of the example embodiments of the present invention.

### BRIEF DESCRIPTION OF THE DRAWINGS

FIG. 1 is a functional block diagram illustrating a distributed data processing environment, in accordance with an embodiment of the present invention;

FIG. 2 is a flowchart illustrating the operational steps of a contextual conversational user assistance program, on a server within the distributed data processing environment of FIG. 1, in accordance with an embodiment of the present invention; and

FIG. 3 depicts a block diagram of components of a computing environment representing the distributed data processing environment of FIG. 1, in accordance with an embodiment of the present invention.

### DETAILED DESCRIPTION

Embodiments of the present invention recognize that generative artificial intelligence (AI), and more specifically the utilization of large learning models (LLM) and conversational AI to augment and support the enterprise workforce, is a rapidly growing sector. Embodiments of the present invention recognize that the replacement and augmentation of typical human workforce activities is on the rise but also recognize that aspects of the human experience may be lost and the absence of those aspects of the human experience may disrupt a workforce ecosystem.

Embodiments of the present invention recognize that the true value of AI lies in an ability of AI to enhance and augment the capabilities of a human worker. This, for example, has been observed in applications including, but not limited to, AI-powered conference call notetaking and AI-powered pair programming. Embodiments of the present invention recognize that, while a generative AI model has significant potential for boosting human productivity using an artifact-in-creation (i.e., a source code), a generative AI model may also help manage a work process and work more effectively.

Embodiments of the present invention recognize, for example, that in many creative domains, people often produce their best work when they are in a state of flow—a mental state characterized by being so absorbed by a task that one's attention is completely held by it. Embodiments of the present invention recognize, however, that a person in a state of flow may find it hard to maintain and may experience fatigue and may need to take a break. In addition, embodiments of the present invention recognize that a person in a state of flow may simply need to “take a step back” during creative problem solving in order to reset their thinking and come up with an alternate approach to solving a problem.

Therefore, embodiments of the present invention recognize the need for and provide a system and method to monitor a user's work in an environment that requires a focused and concentrated effort and where mistakes or errors can be detected. That environment, for example, may include, but is not limited to, a software engineer writing a code, a product manager creating a product plan, a designer creating a UX mockup, and an executive writing a speech. Embodiments of the present invention provide a system and method to determine when an error rate exceeds a statistical bound (e.g., when an error rate exceeds one or two standard deviations above a typical error rate). When the error rate exceeds the statistical bound, the system and method detects that the user is fatigued and/or frustrated (e.g., detects a presence of an error and/or a mistake in the work of the user). Embodiments of the present invention provide a system and method to intervene by invoking a conversational LLM that queries the user about their work and their mental state. During the conversation, the user and the system determine how best to assist the user. For example, the best way to assist the user may be, but is not limited to, helping the user with their work, chatting with the user to provide emotional support, and recommending the user take a break. Embodiments of the present invention provide a system and method to inject a contextualized pause into the interaction between the user and the system based on an analysis of natural language and communication patterns for indicators of fatigue and/or frustration. Lastly, embodiments of the present invention provide a system and method to adapt a persona for a LLM to suit the context.

Implementation of embodiments of the present invention may take a variety of forms, and exemplary implementation details are discussed subsequently with reference to the Figures.

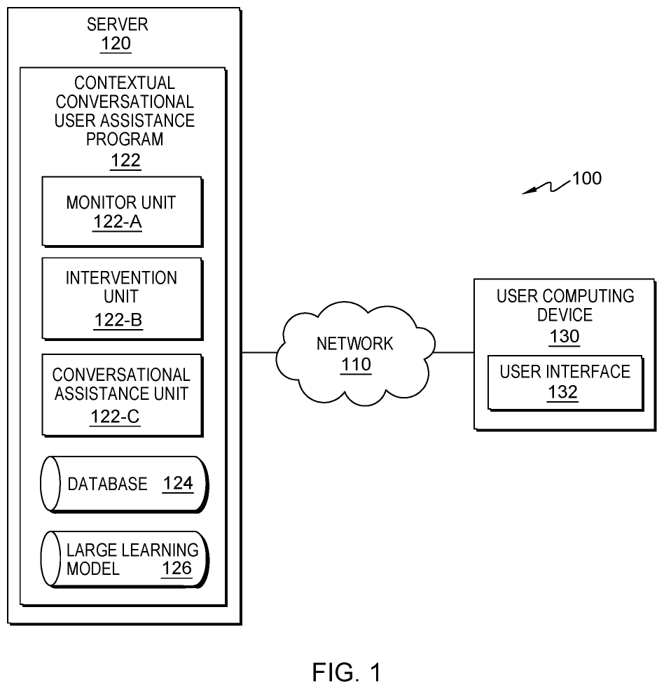

FIG. 1 is a block diagram illustrating a distributed data processing environment, generally designated 100, in accordance with an embodiment of the present invention. In the depicted embodiment, distributed data processing environment 100 includes server 120 and user computing device 130, interconnected over network 110. Distributed data processing environment 100 may include additional servers, computers, computing devices, and other devices not shown. The term “distributed” as used herein describes a computer system that includes multiple, physically distinct devices that operate together as a single computer system. FIG. 1 provides only an illustration of one embodiment of the present invention and does not imply any limitations with regards to the environments in which different embodiments may be implemented. Many modifications to the depicted environment may be made by those skilled in the art without departing from the scope of the invention as recited by the claims.

Network 110 operates as a computing network that can be, for example, a telecommunications network, a local area network (LAN), a wide area network (WAN), such as the Internet, or a combination of the three, and can include wired, wireless, or fiber optic connections. Network 110 can include one or more wired and/or wireless networks capable of receiving and transmitting data, voice, and/or video signals, including multimedia signals that include data, voice, and video information. In general, network 110 can be any combination of connections and protocols that will support communications between server 120, user computing device 130, and other computing devices (not shown) within distributed data processing environment 100.

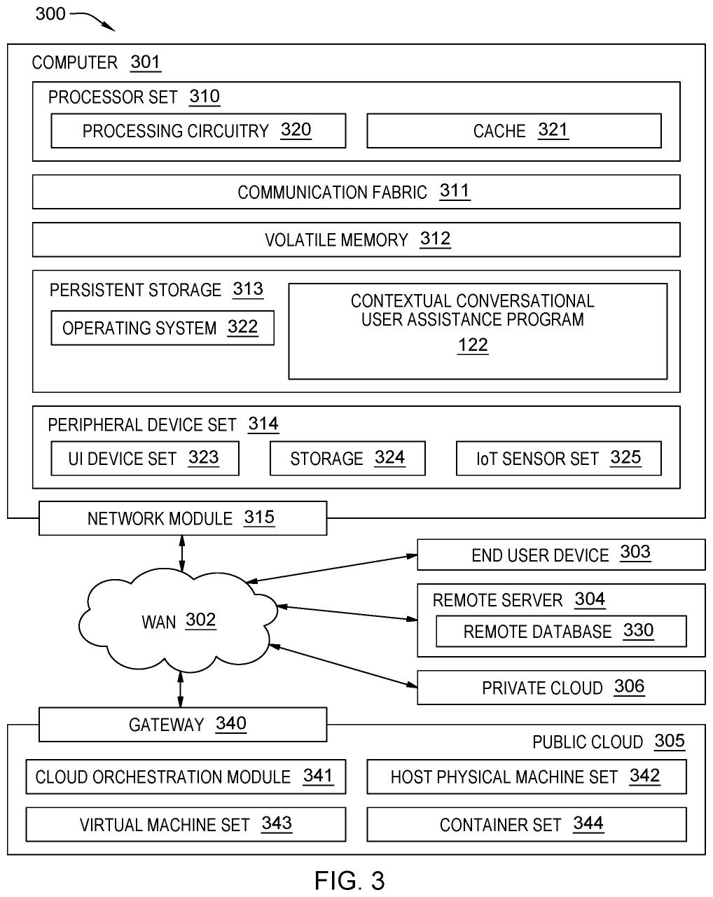

Server 120 operates to run contextual conversational user assistance program 122 and to send and/or store data in database 124. In an embodiment, server 120 can send data from database 124 to user computing device 130. In an embodiment, server 120 can receive data in database 124 from user computing device 130. In an embodiment, server 120 includes contextual conversational user assistance program 122, database 124, and large language model 126. In one or more embodiments, server 120 can be a standalone computing device, a management server, a web server, a mobile computing device, or any other electronic device or computing system capable of receiving, sending, and processing data and capable of communicating with user computing device 130 via network 110. In one or more embodiments, server 120 can be a computing system utilizing clustered computers and components (e.g., database server computers, application server computers, etc.) that act as a single pool of seamless resources when accessed within distributed data processing environment 100, such as in a cloud computing environment. In one or more embodiments, server 120 can be a laptop computer, a tablet computer, a netbook computer, a personal computer, a desktop computer, a personal digital assistant, a smart phone, or any programmable electronic device capable of communicating with user computing device 130 and other computing devices (not shown) within distributed data processing environment 100 via network 110. Server 120 may include internal and external hardware components, as depicted and described in further detail in FIG. 3.

Large Language Model (LLM) 126 operates to capture a communication and a baseline sentiment from a user; to interact with the user; to process the communication and the baseline sentiment from the user for an indication of fatigue and/or frustration; to query a user about an action the user is executing, including, but not limited to, a criticality, a timeline, and an urgency of the action as well as about a mental state of the user; and to adapt a persona to suit the context (i.e., of the action the user is executing and the mental state of the user).

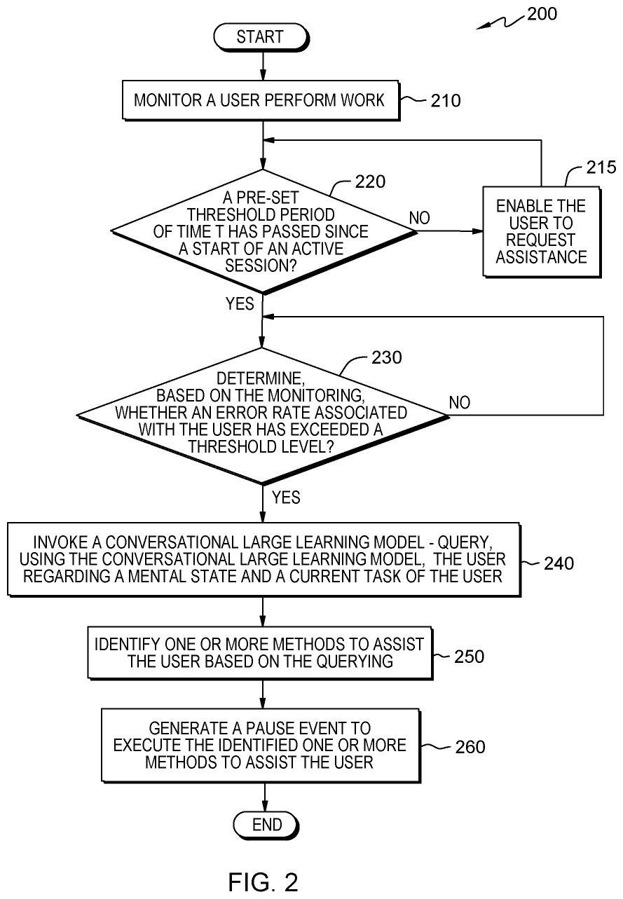

Contextual conversational user assistance program 122 operates to monitor a user's work in an environment in which a focused and concentrated effort is required and in which a mistake and/or an error can be detected; to determine when an error rate exceeds a statistical bound; responsive to the error rate exceeding the statistical bound, to detect that the user is fatigued and/or frustrated; to intervene by invoking a conversational LLM chatbot, e.g., LLM 126, that queries the user about the user's work and the user's mental state; during the conversation, to determine how best to assist the user; and to inject a contextualized pause into the interaction based on an analysis of natural language and communication patterns indicating signs of fatigue and/or frustration. In the depicted embodiment, contextual conversational user assistance program 122 is a standalone program. In another embodiment, contextual conversational user assistance program 122 may be integrated into another software product. In the depicted embodiment, contextual conversational user assistance program 122 includes Monitor Unit 122-A, Intervention Unit 122-B, and Conversational Assistance Unit 122-C. The operational steps of contextual conversational user assistance program 122 are depicted and described in further detail with respect to FIG. 2.

In an embodiment, a user of a user computing device (e.g., user computing device 130) registers with contextual conversational user assistance program 122 of server 120. For example, the user completes a registration process (e.g., user validation), provides information to create a user profile, and authorizes the collection, analysis, and distribution (i.e., opts-in) of relevant data on an identified computing device (e.g., user computing device 130) by server 120 (e.g., via contextual conversational user assistance program 122). Relevant data includes, but is not limited to, personal information or data provided by the user; tagged and/or recorded location information of the user (e.g., to infer context (i.e., time, place, and usage) of a location or existence); time stamped temporal information (e.g., to infer contextual reference points); and specifications pertaining to the software or hardware of the user's device. In an embodiment, the user opts-in or opts-out of certain categories of data collection. For example, the user can opt-in to provide all requested information, a subset of requested information, or no information. In one example scenario, the user opts-in to provide time-based information, but opts-out of providing location-based information (on all or a subset of computing devices associated with the user). In an embodiment, the user opts-in or opts-out of certain categories of data analysis. In an embodiment, the user opts-in or opts-out of certain categories of data distribution. Such preferences can be stored in database 124.

Monitor unit 122-A, during a work session, operates to track an activity being performed by a user and to compute a metric regarding a performance aspect of the activity being performed by the user. Additionally, monitor unit 122-A, during a work session, operates to communicate with intervention unit 122 to report on the performance aspect. In the depicted embodiment, monitor unit 122-A is a component of contextual conversational user assistance program 122 on server 120.

Intervention unit 122-B, during a work session, operates to determine whether a performance of a user, based on the performance aspect communicated from monitor unit 122-A, statistically deviates from an expected performance stored in a user profile of the user indicating an intervention of some kind is needed. In the depicted embodiment, intervention unit 122-B is a component of contextual conversational user assistance program 122 on server 120.

Conversational assistance unit 122-C operates to use current performance data from monitor unit 122-A and historical performance data from the user profile to craft a system prompt for a conversational LLM, e.g., LLM 126, that sets the appropriate context for the conversation—the user's performance has deviated from their historical performance—and a goal of helping the user choose an action (e.g., stepping away from the computer, having a social chat, continuing to work, etc.) if an intervention is deemed necessary by an intervention unit, e.g., intervention unit 122-B. In the depicted embodiment, conversational assistance unit 122-C is a component of contextual conversational user assistance program 122 on server 120.

Database 124 operates as a repository for data received, used, and/or generated by contextual conversational user assistance program 122. A database is an organized collection of data. Data includes, but is not limited to, information about user preferences (e.g., general user system settings such as alert notifications for a user computing device (e.g., user computing device 130)); information about alert notification preferences; a communication and/or a sentiment input by a user; a mental state of the user; a current task of a user; a frustration indicator (e.g., a Natural Language component, a speech, a language choice, a sentiment, and an expletive); a fatigue indicator (e.g., a spelling error, a process indicator (e.g., out of order interactions or improper information), and a “process blind” indicator); a sentiment that is trending for a topic, a temporal timeframe, or a subject; a category of sentiments; one or more factors associated with an action a user is executing (e.g., a degree of criticality of an action a user is executing, a timeline associated with an action a user is executing, and an urgency of an action a user is executing); one or more methods to assist a user (e.g., helping a user with a task, chatting with a user to provide emotional support, and recommending that a user take a break); and any other data received, used, and/or generated by contextual conversational user assistance program 122.

Database 124 can be implemented with any type of device capable of storing data and configuration files that can be accessed and utilized by server 120, such as a hard disk drive, a database server, or a flash memory. In an embodiment, database 124 is accessed by contextual conversational user assistance program 122 to store and/or to access the data. In the depicted embodiment, database 124 resides on server 120. In another embodiment, database 124 may reside on another computing device, server, cloud server, or spread across multiple devices elsewhere (not shown) within distributed data processing environment 100, provided that contextual conversational user assistance program 122 has access to database 124.

The present invention may contain various accessible data sources, such as database 124, that may include personal and/or confidential company data, content, or information the user wishes not to be processed. Processing refers to any operation, automated or unautomated, or set of operations such as collecting, recording, organizing, structuring, storing, adapting, altering, retrieving, consulting, using, disclosing by transmission, dissemination, or otherwise making available, combining, restricting, erasing, or destroying personal and/or confidential company data. Contextual conversational user assistance program 122 enables the authorized and secure processing of personal data and/or confidential company data.

Contextual conversational user assistance program 122 provides informed consent, with notice of the collection of personal and/or confidential company data, allowing the user to opt-in or opt-out of processing personal and/or confidential company data. Consent can take several forms. Opt-in consent can impose on the user to take an affirmative action before personal and/or confidential company data is processed. Alternatively, opt-out consent can impose on the user to take an affirmative action to prevent the processing of personal and/or confidential company data before personal and/or confidential company data is processed. Contextual conversational user assistance program 122 provides information regarding personal and/or confidential company data and the nature (e.g., type, scope, purpose, duration, etc.) of the processing. Contextual conversational user assistance program 122 provides the user with copies of stored personal and/or confidential company data. Contextual conversational user assistance program 122 allows the correction or completion of incorrect or incomplete personal and/or confidential company data. Contextual conversational user assistance program 122 allows for the immediate deletion of personal and/or confidential company data.

User computing device 130 operate to run user interface 132 through which a user can interact with contextual conversational user assistance program 122 on server 120. In an embodiment, user computing device 130 is a device that performs programmable instructions. For example, user computing device 130 may be an electronic device, such as a laptop computer, a tablet computer, a netbook computer, a personal computer, a desktop computer, a smart phone, or any programmable electronic device capable of running user interface 132 and of communicating (i.e., sending and receiving data) with contextual conversational user assistance program 122 via network 110. In general, user computing device 130 represents any programmable electronic device or a combination of programmable electronic devices capable of executing machine readable program instructions and communicating with other computing devices (not shown) within distributed data processing environment 100 via network 110. In the depicted embodiment, user computing device 130 include an instance of user interface 132.

User interface 132 operates as a local user interface between contextual conversational user assistance program 122 on server 120 and a user of user computing device 130. In some embodiments, user interface 132 is a graphical user interface (GUI), a web user interface (WUI), and/or a voice user interface (VUI) that can display (i.e., visually) or present (i.e., audibly) text, documents, web browser windows, user options, application interfaces, and instructions for operations sent from contextual conversational user assistance program 122 to a user via network 110. User interface 132 can also display or present alerts including information (such as graphics, text, and/or sound) sent from contextual conversational user assistance program 122 to a user via network 110. In an embodiment, user interface 132 can send and receive data (i.e., to and from contextual conversational user assistance program 122 via network 110, respectively). Through user interface 132, a user can opt-in to contextual conversational user assistance program 122; input information; create a user profile; set user preferences and alert notification preferences; define a pre-set threshold period of time, a pre-set error threshold level, a pre-set user frustration or fatigue threshold to be used by contextual conversational user assistance program 122; perform work by inputting a plurality of inputs; input a communication; input a baseline sentiment; request assistance; interact with the conversational LLM chatbot; input data regarding one or more factors associated with an action the user is executing; receive ameliorative instructions to perform the one or more methods to assist the user; receive a request for feedback; and input feedback.

A user preference is a setting that can be customized for a particular user. A set of default user preferences are assigned to each user of contextual conversational user assistance program 122. A user preference editor can be used to update values to change the default user preferences. User preferences that can be customized include, but are not limited to, general user system settings, specific user profile settings, alert notification settings, and machine-learned data collection/storage settings. Machine-learned data is a user's personalized corpus of data. Machine-learned data includes, but is not limited to, past results of iterations of contextual conversational user assistance program 122.

FIG. 2 is a flowchart, generally designated 200, illustrating the operational steps for contextual conversational user assistance program 122, on server 120 within distributed data processing environment 100 of FIG. 1, in accordance with an embodiment of the present invention. In an embodiment, contextual conversational user assistance program 122 operates to monitor a user perform work in an environment in which a focused and concentrated effort is required and in which a mistake and/or an error in the work can be detected; to determine when an error rate exceeds a statistical bound; when the error rate exceeds the statistical bound, to detect that the user is fatigued and/or frustrated; to intervene by invoking a conversational LLM chatbot that queries the user about their work and their mental state; during the conversation, to determine how best to assist the user; and to inject a contextualized pause into the interaction based on an analysis of natural language and communication patterns indicating signs of fatigue and/or frustration. It should be appreciated that the process depicted in FIG. 2 illustrates one possible iteration of the process flow, which may be repeated in a polling fashion (e.g., once a single active session or once over a plurality of active sessions) or in an on-demand fashion (e.g., whenever a user requests).

In step 210, contextual conversational user assistance program 122 monitors a user perform work. In an embodiment, contextual conversational user assistance program 122 monitors a user perform work in an environment in which a focused and concentrated effort is required. In an embodiment, contextual conversational user assistance program 122 monitors a user perform work in an environment in which a mistake and/or an error in the work performed by the user can be detected. In an embodiment, contextual conversational user assistance program 122 monitors a user perform work via a plurality of inputs input by the user into a user computing device (e.g., user computing device 130) via a user interface (e.g., user interface 132) of the user computing device (e.g., user computing device 130). In an embodiment, contextual conversational user assistance program 122 monitors a user perform work from a start of an active session. In an embodiment, contextual conversational user assistance program 122 monitors a user perform work in real time.

In decision step 220, contextual conversational user assistance program 122 determines whether a pre-set threshold period of time t has passed since a start of an active session. In another embodiment, contextual conversational user assistance program 122 determines whether a pre-set threshold period of time t has passed since a last pause session enabled by the user. In another embodiment, contextual conversational user assistance program 122 determines whether a pre-set threshold period of time t has passed since a last pause session injected by the system. In an embodiment, contextual conversational user assistance program 122 determines whether a pre-set threshold period of time t has passed to ensure contextual conversational user assistance program 122 does not prompt the user immediately. If contextual conversational user assistance program 122 determines the pre-set threshold period of time t has not passed (decision step 220, NO branch), then contextual conversational user assistance program 122 proceeds to step 215, enabling the user to request assistance. If contextual conversational user assistance program 122 determines the pre-set threshold period of time t has passed (decision step 220, YES branch), then contextual conversational user assistance program 122 proceeds to decision step 230, determining whether an error rate associated with the work performed by the user has exceeded a pre-set error threshold level.

Returning to step 215, contextual conversational user assistance program 122 enables the user to request assistance. In an embodiment, responsive to determining the pre-set threshold period of time t has not passed, contextual conversational user assistance program 122 enables the user to request assistance. In an embodiment, contextual conversational user assistance program 122 enables the user to request assistance to identify one or more methods to relieve the user of a feeling of fatigue and/or frustration. In an embodiment, contextual conversational user assistance program 122 enables the user to request assistance via a user interface (e.g., user interface 132) of a user computing device (e.g., user computing device 130).

In decision step 230, contextual conversational user assistance program 122 determines whether an error rate associated with the work performed by the user has exceeded a pre-set error threshold level. In an embodiment, contextual conversational user assistance program 122 determines whether an error rate associated with the work performed by the user has exceeded a pre-set error threshold level by processing the work of the user. In an embodiment, contextual conversational user assistance program 122 processes the work performed by the user by analyzing the work performed using a Natural Language Processing technique known to those skilled in the art. In an embodiment, contextual conversational user assistance program 122 processes the work performed by the user for an indication of frustration (i.e., a frustration indicator). In an embodiment, contextual conversational user assistance program 122 processes the work performed by the user for an indication of fatigue (i.e., a fatigue indicator). An indication of frustration includes, but is not limited to, a Natural Language component, a speech, a language choice, a sentiment, and an expletive. An indication of fatigue includes, but is not limited to, a spelling error, a process indicator (e.g., out of order interactions or improper information), and a “process blind” indicator. If contextual conversational user assistance program 122 determines an error rate associated with the work performed by the user has exceeded a pre-set error threshold level (decision step 230, YES branch), then contextual conversational user assistance program 122 proceeds to step 240, contextual conversational user assistance program 122 invokes a conversational LLM chatbot, e.g., LLM 126. If contextual conversational user assistance program 122 determines an error rate associated with the work performed by the user has not exceeded a pre-set error threshold level (decision step 230, NO branch), then contextual conversational user assistance program 122 continues to monitor the user perform work.

In step 240, contextual conversational user assistance program 122 invokes a conversational LLM chatbot, e.g., LLM 126. The conversational LLM chatbot agent, e.g., LLM 126 is a conversation agent. In an embodiment, responsive to determining that an error rate associated with the work performed by the user has exceeded a pre-set error threshold level, contextual conversational user assistance program 122 invokes a conversational LLM chatbot, e.g., LLM 126. In an embodiment, contextual conversational user assistance program 122 invokes a conversational LLM chatbot, e.g., LLM 126, with a persona bot profile. In another embodiment, contextual conversational user assistance program 122 invokes a conversational LLM chatbot, e.g., LLM 126, with a non-persona bot profile. In an embodiment, contextual conversational user assistance program 122 initiates a conversation between the user and the conversational LLM chatbot agent, e.g., LLM 126. In an embodiment, contextual conversational user assistance program 122 enables a user to input a communication into the conversation. A communication includes any information input or exchanged. In another embodiment, contextual conversational user assistance program 122 enables a user to input a baseline sentiment. In an embodiment, contextual conversational user assistance program 122 enables a user to input a communication via a user interface (e.g., user interface 132) of a user computing device (e.g., user computing device 130). In an embodiment, contextual conversational user assistance program 122 enables the conversational LLM chatbot agent, e.g., LLM 126, to capture the communication from the user. In an embodiment, contextual conversational user assistance program 122 enables the conversational LLM chatbot agent, e.g., LLM 126, to capture the communication from the user through a single session. In another embodiment, contextual conversational user assistance program 122 enables the conversational LLM chatbot agent, e.g., LLM 126, to capture the communication from the user over a plurality of sessions. In another embodiment, contextual conversational user assistance program 122 enables the conversational LLM chatbot agent, e.g., LLM 126, to capture the communication from the user from a user history stored in a database (e.g., database 124).

In an embodiment, contextual conversational user assistance program 122 detects a sentiment of the user. In an embodiment, contextual conversational user assistance program 122 detects a sentiment of the user from the communication input by the user into the conversation. In an embodiment, responsive to detecting the sentiment of the user, the conversational LLM chatbot agent, e.g., LLM 126, mirrors the sentiment. In an embodiment, the conversational LLM chatbot agent, e.g., LLM 126, mirrors the sentiment to allow for a more life-like experience when interacting with the chatbot. In an embodiment, if the user expresses a sentiment that is trending for a topic, a temporal timeframe, or a subject, the conversational LLM chatbot agent, e.g., LLM 126, adopts an overall sentiment awareness through a Natural Language Processing (NLP) trending criteria. A category of sentiments includes, but is not limited to, a positive sentiment (e.g., an affirmative emotion, such as an emotion that connotes joy, satisfaction, or enthusiasm); a negative sentiment (e.g., a negative emotion, such as an emotion that signifies anger, disappointment, or fear); a neutral sentiment (e.g., a neutral emotion, such as an emotion that lacks a pronounced positive or negative emotion); a mixed sentiment (e.g., a concurrent presentation of positive and negative emotions); an ambivalent sentiment (e.g., a presence of conflicting emotions towards a single subject); a strong sentiment (e.g., a high magnitude of emotional response, either positive or negative); a mild sentiment (e.g., a low magnitude of emotional response, either positive or negative); a subjective sentiment (e.g., an emotion based on personal perspective and interpretation); an objective sentiment (e.g., an emotion inferred from factual, unbiased information); a direct sentiment (e.g., an explicitly expressed sentiment and/or a sentiment that requires no interpretation); an indirect sentiment (e.g., an implied sentiment and/or a sentiment that requires interpretation); a constructive sentiment (e.g., feedback aimed at positive change or improvement); and a destructive sentiment (e.g., negative feedback without improvement suggestions). The categories of sentiment may overlap, as communication may encompass a plurality of sentiment types at a similar period of time. In an embodiment, contextual conversational user assistance program 122 selects a trending indicator of some, all, or any of the above categories of sentiment.

In an embodiment, contextual conversational user assistance program 122 selects a persona for the conversational LLM chatbot, e.g., LLM 126, to query the user, taking into consideration the detected sentiment of the user. In an embodiment, contextual conversational user assistance program 122 queries the user. In an embodiment, contextual conversational user assistance program 122 queries the user regarding a mental state of the user. In an embodiment, contextual conversational user assistance program 122 queries the user regarding a current task being performed by the user. In an embodiment, contextual conversational user assistance program 122 queries the user via the conversational LLM chatbot agent, e.g., LLM 126. In an embodiment, contextual conversational user assistance program 122 enables the user to respond to a query via a user interface (e.g., user interface 132) of a user computing device (e.g., user computing device 130).

In an embodiment, contextual conversational user assistance program 122 processes the conversation between the user and the conversational LLM chatbot agent, e.g., LLM 126. In an embodiment, contextual conversational user assistance program 122 gathers a set of data regarding one or more factors associated with the action the user is executing. The one or more factors associated with the action the user is executing include, but are not limited to, a degree of criticality of an action the user is executing, a timeline associated with an action the user is executing, and an urgency of the action the user is executing. In an embodiment, contextual conversational user assistance program 122 gathers a set of data regarding one or more factors associated with the action the user is executing from a user manual selection. In an embodiment, contextual conversational user assistance program 122 gathers a set of data regarding one or more factors associated with the action the user is executing from an automation selection. In an embodiment, the automatic selection determines if the user has been working continuously. In an embodiment, the automatic selection determines if there are one or more additional factors to consider regarding the action the user is executing. In an embodiment, contextual conversational user assistance program 122 analyzes one or more factors associated with an action the user is executing. In an embodiment, contextual conversational user assistance program 122 analyzes one or more factors associated with an action the user is executing to determine a degree of criticality of an action the user is executing. In an embodiment, contextual conversational user assistance program 122 analyzes one or more factors associated with an action the user is executing to determine a timeline associated with an action the user is executing. In an embodiment, contextual conversational user assistance program 122 analyzes one or more factors associated with an action the user is executing to determine an urgency of the action the user is executing.

In step 250, contextual conversational user assistance program 122 identifies one or more methods to assist the user. In an embodiment, contextual conversational user assistance program 122 identifies one or more methods to assist the user based on the one or more factors associated with an action the user is executing (i.e., based on a criticality, timeline, or urgency of the task). The one or more methods to assist the user include, but are not limited to, helping the user with the task, chatting with the user to provide emotional support, and recommending that the user take a break.

In step 260, contextual conversational user assistance program 122 generates a pause event. A pause event is an action recommended to be taken by a user to improve a performance of the user. In an embodiment, contextual conversational user assistance program 122 contextualizes the pause event to the persona selected for the conversational LLM chatbot, e.g., LLM 126. For example, the persona selected for the conversational LLM chatbot, e.g., LLM 126, is a professor. Contextual conversational user assistance program 122 contextualizes the pause event to the persona selected for the conversational LLM chatbot, e.g., LLM 126, based on a communication input by the user into the conversation. The communication input by the user into the conversation states, “I am going to go ponder on my balcony. I will be back in five minutes.” In another embodiment, contextual conversational user assistance program 122 contextualizes the pause event to the persona or context of the user. For example, the persona selected for the conversational LLM chatbot, e.g., LLM 126, is based on the time of day. Contextual conversational user assistance program 122 contextualizes the pause event to the time of day based on a communication that states, “Hey, it is getting close to dinner. Why don't you grab a bite to eat and come back when you are done?” In another embodiment, contextual conversational user assistance program 122 contextualizes the pause event to an action recommended to improve user performance. For example, the user likes to walk when the user feels fatigued. Contextual conversational user assistance program 122 contextualizes the pause event to the action of walking when feeling fatigued based on a communication that states, “Hey user Z, I am going for a walk. You should come with me.” In an embodiment, contextual conversational user assistance program 122 enables the conversational LLM chatbot agent, e.g., LLM 126, to respond in a humanlike format.

In an embodiment, contextual conversational user assistance program 122 communicates ameliorative instructions to the user. In an embodiment, contextual conversational user assistance program 122 communicates ameliorative instructions to the user explaining the identified one or more methods to be executed to assist the user. In an embodiment, contextual conversational user assistance program 122 communicates ameliorative instructions to the user via the conversational LLM chatbot agent, e.g., LLM 126. In an embodiment, contextual conversational user assistance program 122 communicates ameliorative instructions to the user in a human contextualized format as connected to the persona of the conversational LLM chatbot agent, e.g., LLM 126. In an embodiment, contextual conversational user assistance program 122 executes the one or more methods identified to assist the user. In another embodiment, contextual conversational user assistance program 122 enables the user to execute the one or more methods identified to assist the user.

In a first example of contextual conversational user assistance program 122, user A is a software engineer. User A is writing code for a product. During a long coding session, contextual conversational user assistance program 122 detects that user A is introducing more errors now than user A was 30 minutes ago, as determined by a compiler identifying user A's errors in the code written. Contextual conversational user assistance program 122 intervenes by initiating a conversation between user A and conversational LLM chatbot 126. Conversational LLM chatbot 126 asks user A an open-ended question on how user A is doing. User A responds that user A is on a deadline and is trying to finish writing the code quickly. Conversational LLM chatbot 126 asks user A if conversational LLM chatbot 126 can provide assistance to user A. User A asks conversational LLM chatbot 126 questions about how to implement certain kinds of functionality. Conversational LLM chatbot 126 responds to user A's questions (given that the conversational assistant has access to a code-fluent conversational LLM chatbot) and user A is able to complete user A's work by the deadline.

In a second example of contextual conversational user assistance program 122, user B is a UX designer. User B is creating a mockup of a login screen. User B keeps moving elements around the screen, first to one place then to another place. Contextual conversational user assistance program 122 detects that user B is repeatedly performing the same actions and intervenes by initiating a conversation between user B and conversational LLM chatbot 126. Conversational LLM chatbot 126 asks user B an open-ended question on how user B is doing. User B responds that user B is frustrated and that user B can't figure out a good layout for the UX elements. Conversational LLM chatbot 126 recommends user B take a break from the task at hand. User B agrees and takes a break.

FIG. 3 depicts a block diagram of components of server 120 within distributed data processing environment 100 of FIG. 1, in accordance with an embodiment of the present invention. It should be appreciated that FIG. 3 provides only an illustration of one implementation and does not imply any limitations with regard to the environments in which different embodiments can be implemented. Many modifications to the depicted environment can be made.

Computing environment 300 contains an example of an environment for the execution of at least some of the computer code involved in performing the inventive methods, such as contextual conversational user assistance program 122. In addition to contextual conversational user assistance program 122, computing environment 300 includes, for example, computer 301, wide area network (WAN) 302, end user device (EUD) 303, remote server 304, public cloud 305, and private cloud 306. In this embodiment, computer 301 includes processor set 310 (including processing circuitry 320 and cache 321), communication fabric 311, volatile memory 312, persistent storage 313 (including operating system 322 and contextual conversational user assistance program 122, as identified above), peripheral device set 314 (including user interface (UI), device set 323, storage 324, and Internet of Things (IoT) sensor set 325), and network module 315. Remote server 304 includes remote database 330. Public cloud 305 includes gateway 340, cloud orchestration module 341, host physical machine set 342, virtual machine set 343, and container set 344.

Computer 301, which represents server 120 of FIG. 1, may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 330. As is well understood in the art of computer technology, and depending upon the technology, performance of a computer-implemented method may be distributed among multiple computers and/or between multiple locations. On the other hand, in this presentation of computing environment 300, detailed discussion is focused on a single computer, specifically computer 301, to keep the presentation as simple as possible. Computer 301 may be located in a cloud, even though it is not shown in a cloud in FIG. 3. On the other hand, computer 301 is not required to be in a cloud except to any extent as may be affirmatively indicated.

Processor set 310 includes one, or more, computer processors of any type now known or to be developed in the future. Processing circuitry 320 may be distributed over multiple packages, for example, multiple, coordinated integrated circuit chips. Processing circuitry 320 may implement multiple processor threads and/or multiple processor cores. Cache 321 is memory that is located in the processor chip package(s) and is typically used for data or code that should be available for rapid access by the threads or cores running on processor set 310. Cache memories are typically organized into multiple levels depending upon relative proximity to the processing circuitry. Alternatively, some, or all, of the cache for the processor set may be located “off chip.” In some computing environments, processor set 310 may be designed for working with qubits and performing quantum computing.

Computer readable program instructions are typically loaded onto computer 301 to cause a series of operational steps to be performed by processor set 310 of computer 301 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 321 and the other storage media discussed below. The program instructions, and associated data, are accessed by processor set 310 to control and direct performance of the inventive methods. In computing environment 300, at least some of the instructions for performing the inventive methods may be stored in contextual conversational user assistance program 122 in persistent storage 313.

Communication fabric 311 is the signal conduction paths that allow the various components of computer 301 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 312 is any type of volatile memory now known or to be developed in the future. Examples include dynamic type random access memory (RAM) or static type RAM. Typically, the volatile memory is characterized by random access, but this is not required unless affirmatively indicated. In computer 301, the volatile memory 312 is located in a single package and is internal to computer 301, but, alternatively or additionally, the volatile memory may be distributed over multiple packages and/or located externally with respect to computer 301.

Persistent storage 313 is any form of non-volatile storage for computers that is now known or to be developed in the future. The non-volatility of this storage means that the stored data is maintained regardless of whether power is being supplied to computer 301 and/or directly to persistent storage 313. Persistent storage 313 may be a read only memory (ROM), but typically at least a portion of the persistent storage allows writing of data, deletion of data and re-writing of data. Some familiar forms of persistent storage include magnetic disks and solid-state storage devices. Operating system 322 may take several forms, such as various known proprietary operating systems or open-source Portable Operating System Interface type operating systems that employ a kernel. The code included in contextual conversational user assistance program 122 typically includes at least some of the computer code involved in performing the inventive methods.

Peripheral device set 314 includes the set of peripheral devices of computer 301. Data communication connections between the peripheral devices and the other components of computer 301 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 323 may include components such as a display screen, speaker, microphone, wearable devices (such as goggles and smart watches), keyboard, mouse, printer, touchpad, game controllers, and haptic devices. Storage 324 is external storage, such as an external hard drive, or insertable storage, such as an SD card. Storage 324 may be persistent and/or volatile. In some embodiments, storage 324 may take the form of a quantum computing storage device for storing data in the form of qubits. In embodiments where computer 301 is required to have a large amount of storage (for example, where computer 301 locally stores and manages a large database) then this storage may be provided by peripheral storage devices designed for storing very large amounts of data, such as a storage area network (SAN) that is shared by multiple, geographically distributed computers. IoT sensor set 325 is made up of sensors that can be used in Internet of Things applications. For example, one sensor may be a thermometer and another sensor may be a motion detector.

Network module 315 is the collection of computer software, hardware, and firmware that allows computer 301 to communicate with other computers through WAN 302. Network module 315 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 315 are performed on the same physical hardware device. In other embodiments (for example, embodiments that utilize software-defined networking (SDN)), the control functions and the forwarding functions of network module 315 are performed on physically separate devices, such that the control functions manage several different network hardware devices. Computer readable program instructions for performing the inventive methods can typically be downloaded to computer 301 from an external computer or external storage device through a network adapter card or network interface included in network module 315.

WAN 302 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 303 is any computer system that is used and controlled by an end user (for example, a customer of an enterprise that operates computer 301) and may take any of the forms discussed above in connection with computer 301. EUD 303 typically receives helpful and useful data from the operations of computer 301. For example, in a hypothetical case where computer 301 is designed to provide a recommendation to an end user, this recommendation would typically be communicated from network module 315 of computer 301 through WAN 302 to EUD 303. In this way, EUD 303 can display, or otherwise present, the recommendation to an end user. In some embodiments, EUD 303 may be a client device, such as thin client, heavy client, mainframe computer, desktop computer and so on.

Remote server 304 is any computer system that serves at least some data and/or functionality to computer 301. Remote server 304 may be controlled and used by the same entity that operates computer 301. Remote server 304 represents the machine(s) that collect and store helpful and useful data for use by other computers, such as computer 301. For example, in a hypothetical case where computer 301 is designed and programmed to provide a recommendation based on historical data, then this historical data may be provided to computer 301 from remote database 330 of remote server 304.

Public cloud 305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 305 is performed by the computer hardware and/or software of cloud orchestration module 341. The computing resources provided by public cloud 305 are typically implemented by virtual computing environments that run on various computers making up the computers of host physical machine set 342, which is the universe of physical computers in and/or available to public cloud 305. The virtual computing environments (VCEs) typically take the form of virtual machines from virtual machine set 343 and/or containers from container set 344. It is understood that these VCEs may be stored as images and may be transferred among and between the various physical machine hosts, either as images or after instantiation of the VCE. Cloud orchestration module 341 manages the transfer and storage of images, deploys new instantiations of VCEs and manages active instantiations of VCE deployments. Gateway 340 is the collection of computer software, hardware, and firmware that allows public cloud 305 to communicate through WAN 302.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 306 is similar to public cloud 305, except that the computing resources are only available for use by a single enterprise. While private cloud 306 is depicted as being in communication with WAN 302, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 305 and private cloud 306 are both part of a larger hybrid cloud.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The foregoing descriptions of the various embodiments of the present invention have been presented for purposes of illustration and example but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
monitoring, by one or more processors, a plurality of inputs by a user to a computing device;
responsive to determining, based on the monitoring, that an error rate associated with the plurality of inputs has exceeded a threshold level, invoking, by the one or more processors, a conversational large learning model (LLM);
querying, by the one or more processors, the user regarding a mental state and a task of the user using the conversational LLM;
identifying, by the one or more processors, one or more methods to assist the user based on a response of the user to the querying; and
executing, by the one or more processors, the one or more methods identified to assist the user.

2. The computer-implemented method of claim 1, further comprising:
subsequent to invoking the conversational large learning model, detecting, by the one or more processors, a sentiment of the user; and
selecting, by the one or more processors, a persona of a plurality of personas for the conversational LLM to query the user based on the detected sentiment of the user.

3. The computer-implemented method of claim 1, further comprising;
subsequent to querying the user regarding the mental state and the task of the user using the conversational LLM, processing, by the one or more processors, the response for an indication of frustration of the user; and
processing, by the one or more processors, the response for an indication of fatigue of the user.

4. The computer-implemented method of claim 3, wherein the indication of frustration includes at least one of a Natural Language component, a speech, a language choice, a sentiment, and an expletive, and wherein the indication of fatigue includes at least one of a spelling error, a process indicator, and a process blind indicator.

5. The computer-implemented method of claim 1, further comprising:
analyzing, by the one or more processors, one or more factors associated with an action the user is executing.

6. The computer-implemented method of claim 5, wherein the one or more factors associated with the action the user is executing include at least one of a degree of criticality of the action the user is executing, a timeline associated with the action the user is executing, and an urgency of the action the user is executing.

7. The computer-implemented method of claim 1, wherein the one or more methods identified to assist the user comprise at least one of helping the user with the task, chatting with the user to provide emotional support, and recommending that the user take a break.

8. A computer program product comprising:
one or more computer readable storage media and program instructions stored on the one or more computer readable storage media, the program instructions comprising:
program instructions to monitor a plurality of inputs by a user to a computing device;
responsive to determining, based on the monitoring, that an error rate associated with the plurality of inputs has exceeded a threshold level, program instructions to invoke a conversational large learning model (LLM);
program instructions to query the user regarding a mental state and a task of the user using the conversational LLM;
program instructions to identify one or more methods to assist the user based on a response of the user to the querying; and
program instructions to execute the one or more methods identified to assist the user.

9. The computer program product of claim 8, further comprising:
subsequent to invoking the conversational large learning model, program instructions to detect a sentiment of the user; and
program instructions to select a persona of a plurality of personas for the conversational LLM to query the user based on the detected sentiment of the user.

10. The computer program product of claim 8, further comprising;
subsequent to querying the user regarding the mental state and the task of the user using the conversational LLM, program instructions to process the response for an indication of frustration of the user; and
program instructions to process the response for an indication of fatigue of the user.

11. The computer program product of claim 10, wherein the indication of frustration includes at least one of a Natural Language component, a speech, a language choice, a sentiment, and an expletive, and wherein the indication of fatigue includes at least one of a spelling error, a process indicator, and a process blind indicator.

12. The computer program product of claim 8, further comprising:
program instructions to analyze one or more factors associated with an action the user is executing.

13. The computer program product of claim 12, wherein the one or more factors associated with the action the user is executing include at least one of a degree of criticality of the action the user is executing, a timeline associated with the action the user is executing, and an urgency of the action the user is executing.

14. The computer program product of claim 8, wherein the one or more methods identified to assist the user comprise at least one of helping the user with the task, chatting with the user to provide emotional support, and recommending that the user take a break.

15. A computer system comprising:
one or more computer processors;
one or more computer readable storage media;
program instructions collectively stored on the one or more computer readable storage media for execution by at least one of the one or more computer processors, the stored program instructions comprising:
program instructions to monitor a plurality of inputs by a user to a computing device;
responsive to determining, based on the monitoring, that an error rate associated with the plurality of inputs has exceeded a threshold level, program instructions to invoke a conversational large learning model (LLM);
program instructions to query the user regarding a mental state and a task of the user using the conversational LLM;
program instructions to identify one or more methods to assist the user based on a response of the user to the querying; and
program instructions to execute the one or more methods identified to assist the user.

16. The computer system of claim 15, further comprising:
subsequent to invoking the conversational large learning model, program instructions to detect a sentiment of the user; and
program instructions to select a persona of a plurality of personas for the conversational LLM to query the user based on the detected sentiment of the user.

17. The computer system of claim 15, further comprising;
subsequent to querying the user regarding the mental state and the task of the user using the conversational LLM, program instructions to process the response for an indication of frustration of the user; and
program instructions to process the response for an indication of fatigue of the user.

18. The computer system of claim 17, wherein the indication of frustration includes at least one of a Natural Language component, a speech, a language choice, a sentiment, and an expletive, and wherein the indication of fatigue includes at least one of a spelling error, a process indicator, and a process blind indicator.

19. The computer system of claim 15, further comprising:
program instructions to analyze one or more factors associated with an action the user is executing.

20. The computer system of claim 19, wherein the one or more factors associated with the action the user is executing include at least one of a degree of criticality of the action the user is executing, a timeline associated with the action the user is executing, and an urgency of the action the user is executing.
